(19) United States
(12) Patent Application Publication
(10) Pub. No.: US 2020/0163286 A1
(43) Pub. Date: May 28, 2020

(54) SMART GREENHOUSE AND COMPONENTS THEREOF

(71) Applicants: Hank WILDE, Pittsburgh, PA (US); Stefan VANTCHEV, Pittsburgh (PA)

(72) Inventors: Hank WILDE, Pittsburgh, PA (US); Stefan VANTCHEV, Pittsburgh (PA)

(73) Assignee: PANACEA.AG LLC., Pittsburgh, PA (US)

(21) Appl. No.: 16/695,712

(22) Filed: Nov. 26, 2019

Related U.S. Application Data
(60) Provisional application No. 62/771,533, filed on Nov. 26, 2018.

(51) Int. Cl. A01G 9/26; A01C 21/00; A01G 9/24; A01G 9/18; G05B 15/02

(52) U.S. Cl. CPC A01G 9/26; A01C 21/007; A01G 9/247; G05B 15/02; A01G 9/18; A01G 9/249; A01G 9/246

(57) ABSTRACT

Robotic greenhouses and devices, methods, and systems for operating such robotic greenhouses are described herein.

### CROSS-REFERENCE TO RELATED APPLICATIONS

This application claims priority from U.S. Provisional No. 62/771,533 entitled “Smart Greenhouse and Components Thereof,” filed Nov. 26, 2018 the entirety of which is hereby incorporated by reference.

### GOVERNMENT INTERESTS

Not applicable

### PARTIES TO A JOINT RESEARCH AGREEMENT

Not applicable

### INCORPORATION OF MATERIAL ON COMPACT DISC

Not applicable

### BACKGROUND

Not applicable

### SUMMARY OF THE INVENTION

Various embodiments are directed to methods for optimizing plant growth including the steps of obtaining plant growth variables from sensors positioned to acquire plant growth data from a plurality of plants and transmitting this data to a computer system; obtaining environmental variables from sensors positioned to acquire environmental data from an environment associated with each of the plurality of plants and transmitting this data to the computer system; identifying, by the computer system, plant growth variables and environmental variables associated with optimal plant growth; adjusting, by the computer system, plant growth variables and environmental variables to mimic the optimal plant growth plant growth variables and environmental variables. In some embodiments, the plant growth may be, for example, cameras, ultrasounds, light sensors, temperature sensors, humidity sensors, airflow sensors, height sensors, laser measuring devices, infrared (IR) detectors, water sensors, pH sensors, electrical conductivity (EC) sensors, dissolved oxygen (DO) sensors, chlorine sensors, turbidity sensors, water flow rate sensors, occupancy sensors, weight gauges, strain gauges, and the like and combinations thereof. In some embodiments, adjusting plant growth variables can be carried out by components such as actuators, dosing pumps for fertilizer addition and pH balancing, valves and pumps to control source water and water flow, an ozone system to control DO levels and to remove any unwanted pathogens, HVAC units to control temperature and humidity, CO₂ regulators to control CO₂ levels, dimmers, light intensity adjusters, filter lenses, and the like and combinations thereof. In particular embodiments, the computer system may be a process logic computer. In some embodiments, plant growth variables may be, for example, temperature, humidity, light availability, nutrient availability, water, and the like and combinations thereof.

In some embodiments, the methods may include, for example, the steps of monitoring plant and leaf growth, analyzing plant and leaf growth data, and modifying the nutrient, water, sunlight, humidity, temperature, and the like and combinations thereof. In some embodiments, the methods may further include the step of communicating with one or more remote computer systems through a network. In some embodiments, each of the one more remote computer systems may be associated with a greenhouse or controlled environment agriculture system, and in certain embodiments, the plant growth variables, environmental variables, or combinations thereof may be acquired from sensors in remote greenhouse or controlled environment agriculture system. In various embodiments, each of the one or more remote computer systems may be personal computers, slate or tablet personal computers, telephones, Smartphones, personal digital assistants, and the like and combinations thereof. In some embodiments, the methods may further include the step of comparing plant growth data and environmental data with historic plant growth data and historic environmental data.

Other embodiments are directed to a sensor block and devices, such as robotic greenhouses. The sensor blocks of such embodiments may include one or more imager; one or more plant growth sensors; and one or more ambient sensors. In some embodiments, the one or more plant growth sensors may include, for example, cameras, ultrasounds, light sensors, temperature sensors, humidity sensors, airflow sensors, height sensors, laser measuring devices, infrared (IR) detectors, water sensors, pH sensors, electrical conductivity (EC) sensors, dissolved oxygen (DO) sensors, chlorine sensors, turbidity sensors, water flow rate sensors, occupancy sensors, weight guages, strain gauges, and the like combinations thereof. In some embodiments, the ambient sensors may include, for example, temperature sensors, carbon dioxide (CO₂) sensors, oxygen (O₂) sensors, humidity sensors, airflow sensors, light level sensors, spectrum specific light level sensors, imagers, water quality sensors, pH sensors, electrical conductivity (EC) sensors, dissolved oxygen (DO) sensors, chlorine sensors, turbidity sensors, water flow rate sensors, soil nutrient sensors, and combinations thereof. In some embodiments, the sensor block may further include a device for transmitting data to a router, server, processor, or controller.

### DESCRIPTION OF THE DRAWINGS

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in details so as to not unnecessarily obscure the present invention.

FIG. 1 is an illustration of a platform for growing plants encompassed by the invention.

FIG. 2A is a detailed illustration of one embodiment of the gantry arm illustrated in FIG. 1.

FIG. 2B is a detailed illustration of one embodiment of the gantry arm illustrated in FIG. 1.

FIG. 3 is a schematic of the control system architecture of embodiments of the invention.

FIG. 4 is a schematic of the control system architecture of embodiments of the invention.

FIG. 5 is a schematic of the data transfer of embodiments of the invention.

FIG. 6 is a schematic of a computer control system that is programmed or otherwise configured to implement methods provided herein.

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 μm to 8 μm is stated, 2 μm, 3 μm, 4 μm, 5 μm, 6 μm, and 7 μm are also intended to be explicitly disclosed, as well as the range of values greater than or equal to 1 μm and the range of values less than or equal to 8 μm.

All percentages, parts and ratios are based upon the total weight of the topical compositions and all measurements made are at about 25° C., unless otherwise specified.

The singular forms “a,” “an,” and “the” include plural referents unless the context clearly dictates otherwise. Thus, for example, reference to a “polymer” includes a single polymer as well as two or more of the same or different polymers; reference to an “excipient” includes a single excipient as well as two or more of the same or different excipients, and the like.

The word “about” when immediately preceding a numerical value means a range of plus or minus 10% of that value, e.g, “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g, more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

Various embodiments of the invention are directed to robotic greenhouse components including a gantry robot having an upper support platform, support legs spaced around the upper support platform, upper tracks on opposite sides of the support platform, a movable gantry arm suspended on the upper tracks, and one or more sensor packs operably connected to the gantry arm. In such embodiments, the gantry robot may be attached to a lower platform configured and arranged to grow plants in parallel rows configured to align with the gantry arm. The plants can be grown in soil or hydroponically.

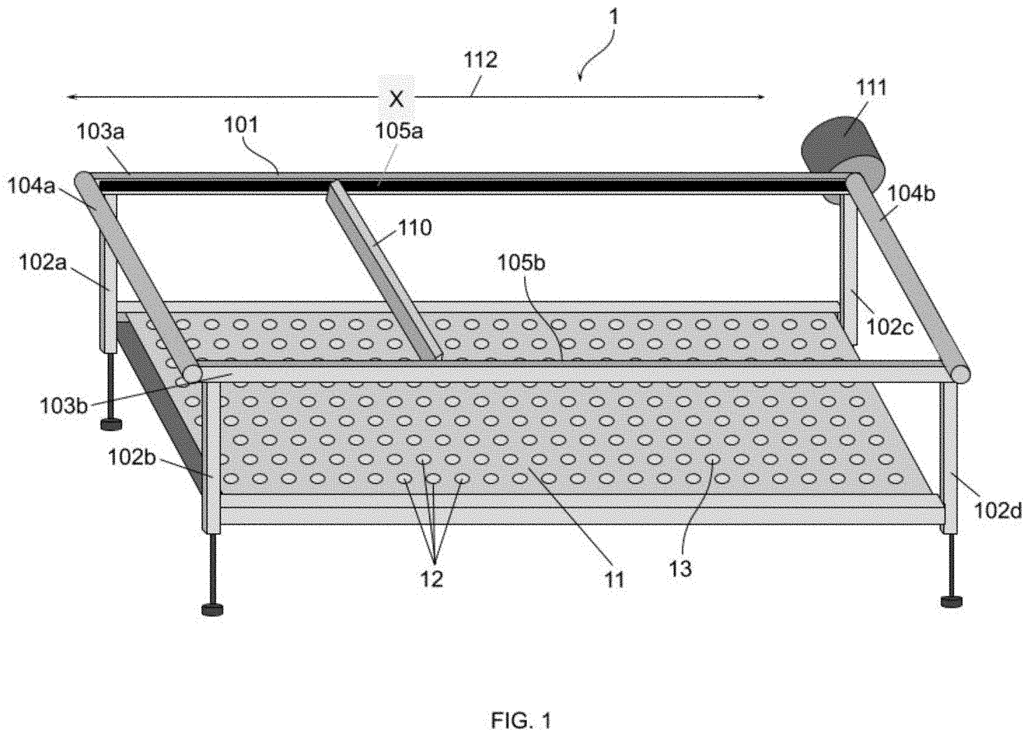

FIG. 1 is an illustrated embodiment of the gantry robot 1 of the invention. The gantry robot 1 includes a lower platform 11 having a plurality of openings 12 configured to receive a growing plants in a controlled environment as discussed herein. In some embodiments, the openings 12 may be sized to receive a container or other pot containing soil in which the plants may grow. In other embodiments, the openings 12 may allow the root system of the plants to be immersed in a hydroponic solution, and in still other embodiments, the openings 12 may contain a medium in which hydroponic plants grow such as a soil substitute or sponge. An upper support platform 101 may be operably connected to the lower platform 11 by a plurality of support legs 102. While the embodiment of FIG. 1 provides four support legs 102a,102b,102c,102d, additional support legs may be provided as necessary to support the weight of the upper support platform 101.

The upper support platform 101 may include lateral supports 103a,103b on long sides of the upper support platform 101 and cross supports 104a,104b perpendicular to the lateral supports. As with the support legs 102, the gantry robot 1 may include more than two cross supports 104 as necessary to provide sufficient rigidity to the upper support platform 101. Upper tracks 105a,105b may be operably connected to the longitudinal supports 103a,103b, and a gantry arm 110 may be movably attached to the upper tracks 105a,105b, which allow the gantry arm to move longitudinally along an X axis. In some embodiments, a drive motor 111 may be configured to move the gantry arm 110, back and forth on the tracks 105a,105b longitudinally relative to the lower platform 11 as illustrated by double headed arrow 112. In some embodiments, a chain or belt drive system may be used to move the gantry arm 110 on tracks 105a,105b. In other embodiments, drive sprockets on opposite sides of the gantry arm 110 may be connected by an axle running through the gantry arm. A motor in the gantry arm 110 may be operably attached to the axle causing the drive sprockets to rotate moving the gantry arm 110 along the tracks 105a,105b. It is understood that other types of drive mechanisms, such as cable drives or other mechanical drives may also be used in other embodiments.

In embodiments, the openings 12 of lower platform 11 may be arranged in a plurality of rows 13 across the platform 11. Each row 13 of openings 12 may extend in a direction transverse to a longitudinal axis of platform 11. Although the example, lower platform include 9 openings 12 per row and 20 rows, any number of rows and openings per row may be used in accordance with the invention.

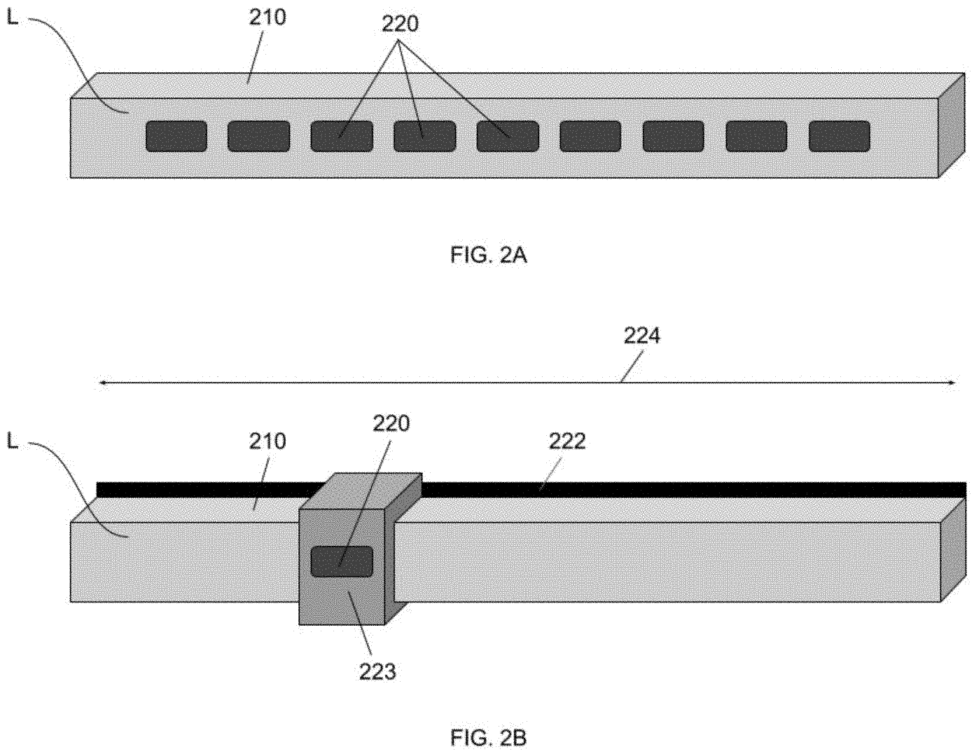

As illustrated in FIG. 2A, the gantry arm 210 may include a plurality of sensors 220 spaced along the lower surface L of the gantry arm 210. The sensors 220 may be spaced and arranged to correspond to the openings 12 on the lower platform 11 (see FIG. 1). Thus, the gantry arm 210 of FIG. 2A includes 9 sensors 220 to correspond with rows 13 having 9 openings 12 as illustrated in FIG. 1. Each sensor 220 may be spaced to photograph and/or otherwise obtain data relating to a plant growing in an opening in a row. The gantry arm 210 may move along the tracks of the upper platform to the next row where each sensor may photograph and/or obtain data relating to plants growing in a neighboring row.

In other embodiments as illustrated in FIG. 2B, a shuttle member 223 having a sensor 220 that rides along on gantry track 222 may be slidably attached to the gantry arm 210. The shuttle members 223 may slide back and forth along the track 222 to photograph and/or obtain data for each plant growing in a row. In various embodiments, the shuttle members 223 may include rollers to facilitate movement of along the gantry arm 210 back and forth in the direction of double headed arrow 224. Shuttle member 223 may be movably coupled to a track 222 provided on the gantry arm 210, and a drive mechanism, such as a chain or belt drive, can be used to move the shuttle member 223 back and forth a direction transverse to the longitudinal axis of support platform. The drive mechanism, therefore, moves the shuttle member 223 back and forth over the rows of openings.

In some embodiments, a sensor as illustrated in FIG. 2A and FIG. 2B may be a single sensor, such as a camera, or multiple sensors. In some embodiments including multiple sensors, each sensor can be independently attached to the gantry arm or shuttle member, and in other embodiments, multiple sensors may be incorporated into a sensor block that can reversibly attach to the gantry arm to ease replacement of worn or malfunctioning sensors. The sensors 220 of various embodiments may be any sensors known and useful in the art. For example, sensors such as cameras, light sensors, temperature sensors, humidity sensors, airflow sensors, height sensors, such as laser measuring devices, infrared (IR) detectors for determining surface temp, water sensors for, pH, electrical conductivity (EC), dissolved oxygen (DO), chlorine, temperature, turbidity, and flow rate, occupancy sensors, and weight or strain gauges the like and combinations thereof can be independently attached to the gantry arm or included on a sensor block. In some embodiments, the gantry arm or sensor block may further include a mister, a bug zapper, or combinations thereof. In some embodiments, the gantry arm may include outer sensors to detect movement near the system. If the outer sensors detect movement, the controller may stop operations of the system until the area is clear when the controller may restart the data acquisition process.

The sensor block or individual sensors may include a wifi enabled chip capable of transmitting data from the sensors to a central router in the greenhouse or elsewhere on the farm. In other embodiments, the sensor block or individual sensors may include other wifi, Bluetooth, or any wireless or wired technology for data transmission. In various embodiments, the sensors may be wired directly into the wifi, Bluetooth, or other transmission chip. Other components such as, for example, motors, and actuators associated with the gantry arm or other components of the greenhouse may be wired into their own transmission chips, which allow them to communicate with a central router and/or controller, processor, or server via the wifi.

The upper upper support platform, tracks, and gantry arms and various motors and sensors associated therewith may be operably connected to a system controller via transmission chips. The system controller controls the movement of gantry arm and, in some embodiments, the shuttle member. For example, motors, drive mechanisms, or actuators that move the gantry arm back and forth in over various rows of openings, and that move a shuttle member back and forth over the particular row to obtain data for the plants growing in the openings may be under the control of the control system and each independently communicate with the control system via individual transmission chips. As such, data collection may be carried out at various times without the need for user input.

In certain embodiments, each sensor may independently acquire data from the plants growing in openings throughout the growth cycle of the plant. For example, data may be acquired hourly, daily, twice per day, weekly, 2, 3, 4, 5, or 6 times per week, monthly, bimonthly, or any time period encompassed by these examples. In some embodiments, the sensors may automatically transmit data to a central router, controller, processor, or server using transmission chips, such as those described above.

In operation, the gantry arm may be illustratively located near one end of the support platform at the start of the process. The gantry may be moved into alignment with the next row of openings or pots. Controller may cause the imagers to create as image of the plants within openings of the row and/or acquire data from the various sensors associated with the gantry arm or sensor block. In some embodiments, the controller may adjust the movement of the gantry arm sensor block after an image or images are obtained to ensure the plant subjects of the image are properly framed and focused. Data from imagers and any other sensors may be stored in memory by controller either locally at the site of the greenhouse or at an offsite server. After data has been acquired, the controller may cause the gantry arm to move to the next row of openings or pots and obtain necessary data from this row. When the final row is reached, the controller may cause the gantry arm to move back to a home position.

In this way, the robotic greenhouse may include systems for collecting plant specific data such as photographs, videos, color, texture, and/or weight, etc. The robotic greenhouse may further include systems for collecting ambient data, such as ambient sensors for temperature, carbon dioxide (CO₂), oxygen (O₂), relative humidity, airflow, light levels, spectrum specific light levels, photos, videos, water quality data, nutrient data, and the like. Such systems may include chips or devices for transmitting all such data to router, server, processor, or controller where it can be stored, aggregated, analyzed, and compared with output measurements. The robotic greenhouse can be expanded to include instrumentation for the measurement of various additional variables in the ambient environment, in the water, from each individual plant, from entire levels, from entire crops, and/or any combination of the above.

The robotic greenhouse of some embodiments may include various additional components not associated with platforms discussed above. For example, in some embodiments, the robotic greenhouse may include a control system for controlling intake and/or exhaust fans to modulate the uptake of external air. Introducing external air may be used as an effective way to cool the greenhouse in cold weather climates, thereby reducing cooling costs and/or improving overall efficiency. External air can also include high levels of CO₂. In some embodiments, the robotic greenhouse may include, for example, mechanical shades to modulate the amount or intensity of sunlight, and temperature of the greenhouse, misting or humidifying devices to increase the humidity in the greenhouse, dehumidifiers to reduce the humidity in the greenhouse, and the like and combinations thereof provided to modulate the ambient environment within the greenhouse.

Actuators and devices associated with such components can be controlled via any number of control methodologies including 0-10V outputs, 0-5 A outputs, 2-20 A outputs, Bluetooth, wife, other analog current, other analog voltage, and/or other digital protocols, etc. Control systems for monitoring and/or regulating CEAs are provided. In examples, control systems may be used to implement a method for communicating with the internet, a process logic computer (PLC), a plurality of sensors, and a plurality of actuators.

The control system communicates with the internet via a router used to communicate with sensors, actuators, servers, controllers, processors, and any additional switches or devices. A PLC allows the user to specify how many sensors and actuators and of what type are required and choose the appropriate number of analog or digital expansion I/O modules to support the required instrumentation. A PLC may provide a robust on-site execution of all processes, while insulating the system from failure as a result of a loss of connectivity. Any other PLC with expandable I/O modules is also appropriate. In some embodiments, logic functions of the PLC can be pushed closer to the instrumentation by incorporating smart logic chips onto individual sensors and actuators. In some embodiments, logic functions of the PLC can also be moved to the cloud and all computing can be done in the internet. There are advantages and disadvantages to all three of these designs, and the final decision to use a physical PLC was made due to a strong preference for robust reliability in the process.

I/O modules are currently current input and current output modules (0-5 mA and 4-20 mA) and voltage input and voltage output modules (0-10V), as these are industry standard communication protocols, but any other electrical, mechanical, acoustic or other signal would also be appropriate, including wi-fi, Bluetooth, Ethernet IP, HART, Modbus TCP, etc. As discussed above, the robotic greenhouse may include an assortment of sensors that can be customized according to the grower's needs, including, but are not limited to water sensors for pH, electrical conductivity (EC), dissolved oxygen (DO), chlorine, temperature, turbidity, and flow rate, ambient sensors for temperature, CO₂, relative humidity, airflow, light levels, spectrum specific light levels, photos, videos, occupancy sensors, and weight or strain gauges.

In some embodiments, the robotic greenhouse may further include actuators or other devices that control the composition of water in a hydroponic system or that add fertilizer to soil in which the plants under observation are growing. For example, in some embodiments, actuators may be attached to reservoirs containing macronutrients such as, nitrogen (N), phosphorous (P), potassium (K), magnesium (Mg), sulfur (S), calcium (Ca), and the like, micronutrients such as, chlorine, molybdenum, copper, iron, manganese, zinc, boron, and the like in solid (salt) or liquid (solution) form that can be introduced into liquid streams for plants grown hydroponically or sprayed onto or introduced into the soil of plants grown in soil. In other embodiments, such reservoirs may contain combinations of macronutrients and micronutrients. Each actuator may provide a measured dose of a macronutrient, a micronutrient, fertilizer, or combinations thereof into the water or soil in which a plant is growing on the command of the controller or processor. Thus, the processor may increase the amount of any macronutrient, micronutrient, fertilizer composition, or combinations of such components based on data acquired by the sensors.

Data from these sensors can be processed by a sophisticated machine learning algorithm that enables smart control of the actuators thereby optimizing all environmental conditions. The control system includes the following actuators, dosing pumps for fertilizer addition and pH balancing, valves and pumps to control source water and water flow, an ozone system to control DO levels and to remove any unwanted pathogens, HVAC units to control temperature and humidity, CO₂ regulators to control CO₂ levels, dimmers on all lights to control both overall light level as well as intensity of each individual color (450 nm, 660 nm, 520 nm, etc.), and several others. These actuators are only a sampling of the possible configurations, and hundreds of different actuators could be added to the system.

In embodiments, the data acquired during such processes may be analyzed by the controller either locally or on a processor at a data repository or off site server. Analyzing can include various operations designed to evaluate the health of the plants grown by the systems, and in some embodiments, the controller may adjust one or more parameters associated with the greenhouse, soil or water conditions, availability of light, temperature, and the like and combinations thereof.

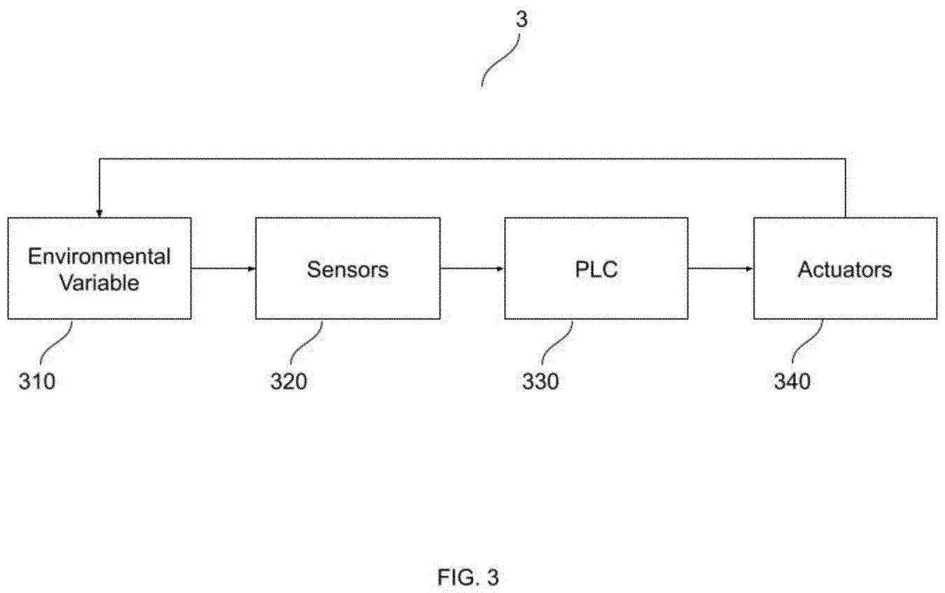

FIG. 3 illustrates an overview of a control system architecture 3, encompassed by the invention. Environmental variables 310 may be monitored by a sensor 320. The sensor may send data to the PLC 330, which may adjust an actuator or other device associated with environmental controls 340. The actuator 340, in turn, may affect the original environmental variable 310, forming a feedback loop. By such processes, environmental conditions may be maintained to produce optimal yield.

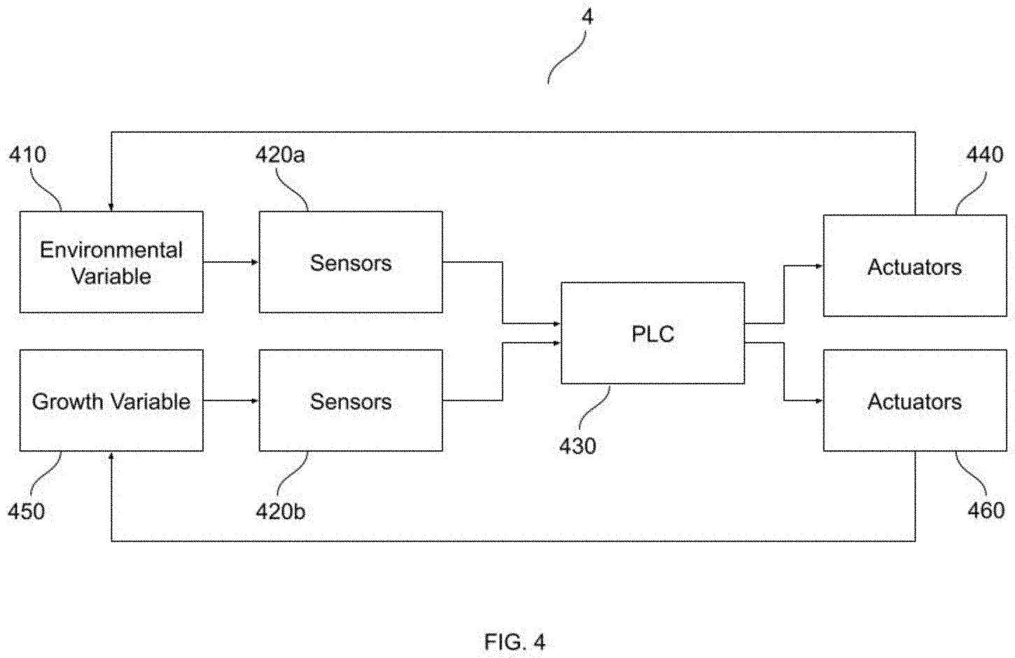

FIG. 4 illustrates an overview of another control system architecture 3, encompassed by the invention that can be run independently or in concert with the control system described in FIG. 3. Environmental variable 410 and plant growth variable 450 may be monitored by sensors 420a,420b. Each sensor 420a,420b may send data to the PLC 430, which may adjust an actuator or other device associated with environmental controls 440 or growth condition controls 470 such as water or soil composition. The actuator 440,460 may, in turn, affect the original environmental variable 410 or growth variable 450 to maintain optimal growing conditions.

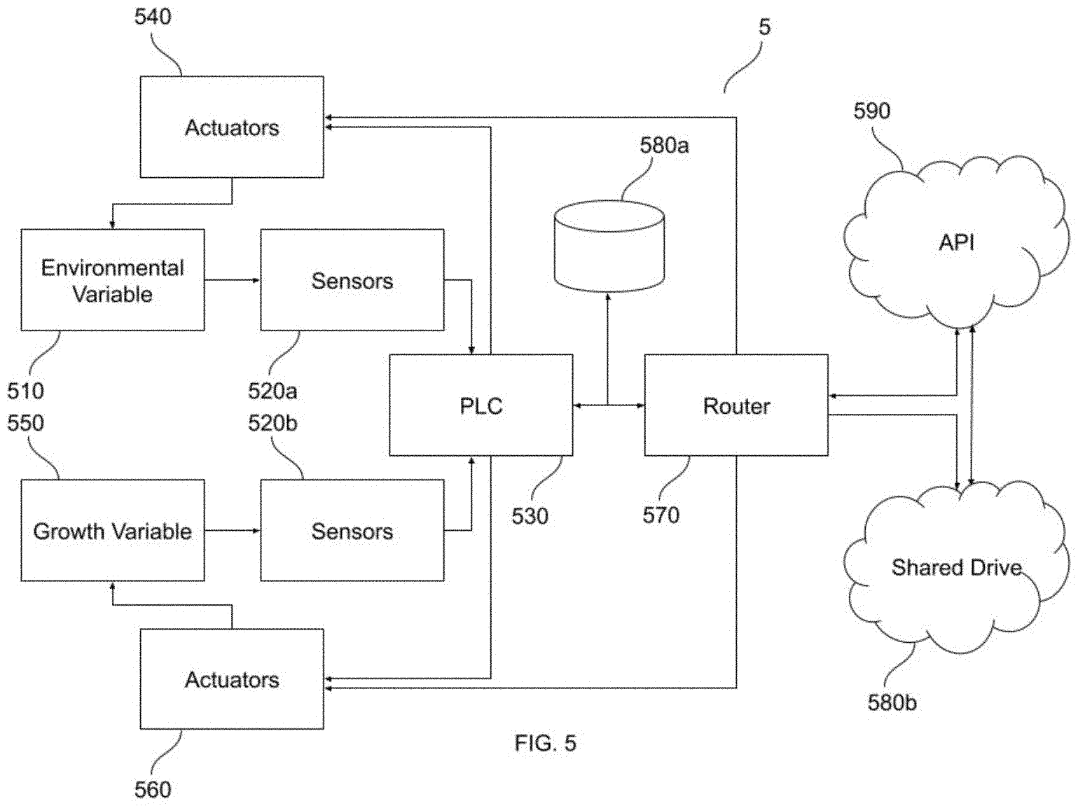

FIG. 5 illustrates a process of data transfer 5, encompassed by the invention, which can be run independently or in concert with the control systems described in FIG. 3 and FIG. 4. In some embodiments, data may be transferred from the PLC 530 to a local drive 580a or a cloud other shared drive 580b. The local drive 580a may be directly connected to the PLC 530, or the local drive 580a may be connected to a router 570. In embodiments in which a cloud or shared drive 580b is used, data may flow from the PLC 530 to a router 570 to the cloud or shared drive 580b. In some embodiments, data may be transferred from a cloud or shared drive 580b to an application programming interface (API) 590, which allows a program to analyze the data and creates instructions for the PLC 530 to cause actuators 540,560 to affect an environmental variable 510 or a growth variable 550. In other embodiments, the PLC 530 may send data directly to the API 590 for analysis and instructions for the PLC 530 and actuators 540,560.

In various embodiments, the PLC 530 may maintain primary control over the entire greenhouse to maintain optimal growth conditions. As such minor variations in environmental conditions may be corrected by instructions from the PLC 530. At the same time, the PLC may transmit data collected from the sensors to the cloud or shared drive 580b where it can be collected, analyzed, and compared to historic data and data collected from other sites by the API 590. If the API detects an anomaly in the data, the API 590 may transmit instructions to the PLC 530 to environmental variable actuators 540, growth variable actuators 560, or combinations thereof to modify growing conditions in the robotic greenhouse.

Further embodiments include computer control systems that are programmed to implement the various methods described above. FIG. 6 shows a computer system 601 that is programmed or otherwise configured to monitor and regulate the robotic greenhouses of various embodiments described above. The greenhouses 60a,60b,60c,60d are connected to computer system 601 through network 602. The computer system 601 can regulate various aspects of monitoring and regulating robot greenhouses 60a,60b,60c,60d, such as, for example, monitoring and regulating, temperature, humidity, light availability, nutrient availability, and the like and combinations thereof. In some embodiments, methods include monitoring plant and leaf growth using visually using a camera or by ultrasound, analyzing the visual or ultrasound data, and modifying the nutrient, water, sunlight, humidity, temperature, and the like to maximize growth of the plant.

The computer system 601 may include a central processing unit (“CPU,” “processor,” or “computer processor”) 605, and the CPU 605 can be a single core or multi core processor, or a plurality of processors for parallel processing. The computer system 601 may also include memory 606 (e.g., random-access memory, read-only memory, flash memory), electronic storage unit 607 (e.g., hard disk), communication interface 608 (e.g., network adapter) for communicating with one or more other systems, and peripheral devices 609, such as cache, other memory, data storage and/or electronic display adapters. The memory 606, storage unit 607, interface 608 and peripheral devices 609 may be in communication with the CPU 605 through a communication bus (solid lines), such as a motherboard. The storage unit 607 can be a data storage unit (or data repository) for storing data.

The computer system 601 can be operatively coupled to a computer network (“network”) 602 with the aid of the communication interface 608. The network 602 can be the Internet, an internet and/or extranet, or an intranet and/or extranet that is in communication with the Internet. The network 602 in some cases is a telecommunication and/or data network. The network 602 can include one or more computer servers, which can enable distributed computing, such as cloud computing. The network 602, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 606. The instructions can be directed to the CPU 605, which can subsequently program or otherwise configure the CPU 605 to implement methods of the present disclosure. Examples of operations performed by the CPU 605 can include fetch, decode, execute, and writeback. The CPU 605 can be part of a circuit, such as an integrated circuit. One or more other components of the system 601 can be included in the circuit. In some cases, the circuit is an application specific integrated circuit (ASIC).

The storage unit 607 can store files, such as drivers, libraries and saved programs. The storage unit 607 can store user data, e.g., user preferences and user programs. The computer system 601 in some cases can include one or more additional data storage units that are external to the computer system 601, such as located on a remote server that is in communication with the computer system 601 through an intranet or the Internet.

The computer system 601 can communicate with one or more remote computer systems through the network 602. For example, the computer system 601 can communicate with a remote computer system of another robotic greenhouse. In FIG. 6, four controlled environment agriculture systems 60a,60b,60c,60d are provided. Examples of remote computer systems include personal computers, slate or tablet PC's, telephones, Smartphones, or personal digital assistants. The user can access the computer system 601 via the network 602.

Methods as described herein can be implemented by way of machine (e.g., computer processor) executable code stored on an electronic storage location of the computer system 601, such as, for example, on the memory 606 or electronic storage unit 607. The machine executable or machine readable code can be provided in the form of software. During use, the code can be executed by the processor 605. In some cases, the code can be retrieved from the storage unit 607 and stored on the memory 606 for ready access by the processor 605. In some situations, the electronic storage unit 607 can be precluded, and machine-executable instructions are stored on memory 606.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 610 that comprises a user interface (UI) 611 for providing, for example, the ability to monitor and/or regulate multiple robotic greenhouse systems at the same time and/or from one user interface. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605. The algorithm can, for example, monitor growth of a given plant in a horticultural high-density growing system; receiving an indication of the progress of growth (e.g., size of plant, leaf density, color, number of leaves, height of the plants, or other available health information of a plant or row of plants); associate the growth characteristic with a stage of growth of the given plant; and modify growing conditions of the given plant based on the determined stage of growth of the given plant.

1. A method for optimizing plant growth comprising:
obtaining plant growth variables from sensors positioned to acquire plant growth data from a plurality of plants and transmitting this data to a computer system;
obtaining environmental variables from sensors positioned to acquire environmental data from an environment associated with each of the plurality of plants and transmitting this data to the computer system;
identifying, by the computer system, plant growth variables and environmental variables associated with optimal plant growth;
adjusting, by the computer system, plant growth variables and environmental variables to mimic the optimal plant growth plant growth variables and environmental variables.

2. The method of claim 1, wherein the plant growth sensors are selected from the group consisting of cameras, ultrasounds, light sensors, temperature sensors, humidity sensors, airflow sensors, height sensors, laser measuring devices, infrared (IR) detectors, water sensors, pH sensors, electrical conductivity (EC) sensors, dissolved oxygen (DO) sensors, chlorine sensors, turbidity sensors, water flow rate sensors, occupancy sensors, weight guages, strain gauges, and combinations thereof.

3. The method of claim 1, wherein adjusting plant growth variables is carried out by components selected from the group consisting of actuators, dosing pumps for fertilizer addition and pH balancing, valves and pumps to control source water and water flow, an ozone system to control DO levels and to remove any unwanted pathogens, HVAC units to control temperature and humidity, CO₂ regulators to control CO₂ levels, dimmers, light intensity adjusters, filter lenses, and combinations thereof.

4. The method of claim 1, wherein the computer system is a process logic computer.

5. The method of claim 1, wherein the plant growth variables are selected from the group consisting of temperature, humidity, light availability, nutrient availability, water, and combinations thereof.

6. The method of claim 1, further comprising one or more of monitoring plant and leaf growth, analyzing plant and leaf growth data, and modifying the nutrient, water, sunlight, humidity, and temperature.

7. The method of claim 1, further comprising communicating with one or more remote computer systems through a network.

8. The method of claim 7, wherein each of the one more remote computer systems are associated with a greenhouse or controlled environment agriculture system.

9. The method of claim 8, wherein the plant growth variables, environmental variables, or combinations thereof are acquired from sensors in remote greenhouse or controlled environment agriculture system.

10. The method of claim 7, wherein each of the one or more remote computer systems are selected from the group consisting of personal computers, slate or tablet personal computers, telephones, Smartphones, personal digital assistants, and combinations thereof.

11. The method of claim 1, further comprising comparing plant growth data and environmental data with historic plant growth data and historic environmental data.

12. A sensor block comprising:
one or more imager;
one or more plant growth sensors; and
one or more ambient sensors.

13. The sensor block of claim 12, wherein the one or more plant growth sensors are selected from the group consisting of cameras, ultrasounds, light sensors, temperature sensors, humidity sensors, airflow sensors, height sensors, laser measuring devices, infrared (IR) detectors, water sensors, pH sensors, electrical conductivity (EC) sensors, dissolved oxygen (DO) sensors, chlorine sensors, turbidity sensors, water flow rate sensors, occupancy sensors, weight gauges, strain gauges, and combinations thereof.

14. The sensor block of claim 12, wherein the ambient sensors are selected from sensors for temperature sensors, carbon dioxide (CO₂) sensors, oxygen (O₂) sensors, humidity sensors, airflow sensors, light level sensors, spectrum specific light level sensors, imagers, water quality sensors, pH sensors, electrical conductivity (EC) sensors, dissolved oxygen (DO) sensors, chlorine sensors, turbidity sensors, water flow rate sensors, soil nutrient sensors, and combinations thereof.

15. The sensor block of claim 12, further comprising a device for transmitting data to a router, server, processor, or controller.

16. A device comprising the sensor block of claim 12.
